(19) United States
(12) Patent Application Publication
(10) Pub. No.: US 2017/0155978 A1
(43) Pub. Date: Jun. 1, 2017

(54) WEARABLE DEVICE AND VEHICLE

(71) Applicant: HYUNDAI MOTOR COMPANY, Seoul (KR)

(72) Inventor: Seungryong NOH, Incheon (KR)

(21) Appl. No.: 15/091,814

(22) Filed: Apr. 6, 2016

(30) Foreign Application Priority Data
Nov. 27, 2015 (KR) 10-2015-0167528

(51) Int. Cl. H04Q 9/00; A63B 24/00

(52) U.S. Cl. CPC H04Q 9/00; A63B 24/0062; H04Q 2209/43; H04Q 2209/84; H04Q 2209/50; A63B 2220/40; A63B 2220/836

(57) ABSTRACT

A wearable device and a vehicle capable of precisely measuring physical activities only in the case the physical activities are a target of exercise by excluding additional physical activities generated by driving a vehicle from the target of exercise to be measured when a user drives the vehicle while wearing a wearable device and the physical activities are measured. A method of controlling the wearable device includes obtaining movement information of a user, excluding the movement information of the user obtained while the user is driving the vehicle from recording or displaying the movement information of the user when it is checked through the movement information of the user that the user is driving a vehicle, and continuing to measure the movement information of the user and resuming the recording and displaying of the movement information of the user when it is determined that the user finishes driving the vehicle.

### CROSS-REFERENCE TO RELATED APPLICATION

This application claims the benefit of priority to Korean Patent Application No. 10-2015-0167528, filed on Nov. 27, 2015 in the Korean Intellectual Property Office, the disclosure of which is incorporated herein by reference.

### TECHNICAL FIELD

Embodiments of the present disclosure relate to a wearable device and a vehicle.

### BACKGROUND

Wearable devices are electronic devices worn by or attached to a body like glasses, watches, and accessories. Since carried as if a part of body, wearable devices have the advantages of being easily usable at any time anywhere and in continuous communication with users. Without using hands, detailed information on surroundings or personal physical changes are continuously recorded by the wearable devices. Such portability provided by the wearable devices is more useful in situations when it is impossible to directly use portable personal computers (PC), phones, and smart phones.

Research on wearable devices started in the U.S.A. in 1960s. In 1980s, the uniform of the US Army which is the first wearable device product was released. With continuous research and development, smart training shoes capable of checking the amount of movement of a user were released in 2006, and the wearable devices have been received great attention in the market.

When a user does physical activities while wearing a wearable device such as smart training shoes, the amount of movement of the user is measured. When the user gets in a vehicle and drives while exercising, additional physical activities generated during a process of driving the vehicle may be measured as if pure physical activities to be measured using the wearable device. Additional physical activities generated by a driver while driving the vehicle are only for driving the vehicle, not a target of exercise, and thus are necessary to be distinguished from the pure physical activities.

### SUMMARY

Therefore, it is an aspect of the present disclosure to precisely measure physical activities only in the case that the physical activities are a target of exercise by excluding additional physical activities caused by driving a vehicle from the target of exercise to be measured when a user drives the vehicle while wearing a wearable device and the physical activities are measured.

That is, unique physical activities generated during a process of driving a vehicle are excluded from a target of exercise to be measured, and only pure physical activities where physical activities are the target of exercise are measured as meaningful physical activities.

Additional aspects of the disclosure will be set forth in part in the description which follows and, in part, will be obvious from the description, or may be learned by practice of the disclosure.

In accordance with one aspect of the present disclosure, a method of controlling a wearable device includes obtaining movement information of a user, excluding the movement information of the user obtained while the user is driving the vehicle from recording or displaying when it is determined through the movement information of the user that the user is driving a vehicle and continuing to measure the movement information of the user and resuming the recording or displaying of the movement information when it is determined that the user finishes driving the vehicle.

The movement information of the user may include movement information of a body part on which the wearable device is located.

The wearable device may be located on an ankle of the user.

The wearable device may be located on a shoe on a foot of the user.

The movement information may be movement information generated while a left foot of the user operates a clutch pedal of the vehicle.

The movement information may be movement information generated while a right foot of the user operates at least one of an accelerator pedal and a brake pedal of the vehicle.

In accordance with another aspect of the present disclosure, a method of controlling a wearable device includes obtaining movement information of a user, performing communication with a vehicle, excluding the movement information of the user obtained while the user is driving the vehicle from recording or displaying when it is determined through the communication with the vehicle that the user is driving the vehicle, and continuing to measure the movement information of the user and resuming the recording or displaying of the movement information when it is determined that the user finishes driving the vehicle.

The wearable device may obtain driving information of the vehicle through the communication with the vehicle.

The driving information of the vehicle may be obtained from an electronic control unit (ECU) of the vehicle through communication between the ECU and the wearable device.

The driving information of the vehicle may be obtained from a multimedia device of the vehicle through communication between the multimedia device and the wearable device.

The driving information of the vehicle may be obtained from a telematics device of the vehicle through communication between the telematics device and the wearable device.

The driving information of the vehicle may include at least one of engine-starting information, speed-changing information, and speed information.

In accordance with still another aspect of the present disclosure, a wearable device includes a detector for obtaining movement information of a user and a controller which excludes the movement information of the user obtained while the user is driving a vehicle from recording or displaying when it is determined through the movement information of the user that the user is driving and continues to measure the movement information of the user and resumes the recording or displaying of the movement information when it determined that the user finishes driving the vehicle.

The detector may include an acceleration sensor for detecting physical activities of the user.

The movement information of the user may include movement information of a body part on which the wearable device is put.

The wearable device may be located on an ankle of the user.

The wearable device may be located on a shoe on a foot of the user.

The movement information may be movement information generated while a left foot of the user operates a clutch pedal of the vehicle.

The movement information may be movement information generated while a right foot of the user operates at least one of an accelerator pedal and a brake pedal of the vehicle.

In accordance with yet another aspect of the present disclosure, a wearable device includes a detector for obtaining movement information of a user, a communicator for performing communication with a vehicle, and a controller which excludes the movement information of the user obtained while the user is driving the vehicle from recording or displaying when it is determined through the communication with the vehicle that the user is driving the vehicle and continues to measure the movement information of the user and resumes the recording or displaying of the movement information when it is determined that the user finishes driving the vehicle.

The controller may obtain driving information of the vehicle through the communication with the vehicle.

The controller may obtain the driving information of the vehicle from an ECU of the vehicle through communication with the ECU.

The controller may obtain the driving information of the vehicle from a multimedia device of the vehicle through communication with the multimedia device.

The controller may obtain the driving information of the vehicle from a telematics device of the vehicle through communication with the telematics device.

The driving information of the vehicle may include at least one of engine-starting information, speed-changing information, and speed information.

In accordance with even another aspect of the present disclosure, a vehicle includes a communicator for performing communication with a wearable device and a controller providing driving information of the vehicle to the wearable device when a request for the driving information of the vehicle is submitted from the wearable device.

The vehicle may further include an ECU provided to transmit the driving information of the vehicle to the wearable device.

The vehicle may further include a multimedia device provided to transmit the driving information of the vehicle to the wearable device.

The vehicle may further include a telematics device provided to transmit the driving information of the vehicle to the wearable device.

### BRIEF DESCRIPTION OF THE DRAWINGS

These and/or other aspects of the disclosure will become apparent and more readily appreciated from the following description of the embodiments, taken in conjunction with the accompanying drawings of which:

FIG. 1 is a view illustrating various types of wearable devices in accordance with one embodiment of the present disclosure;

FIG. 2 is a view of a smart ankle band in accordance with one embodiment of the present disclosure;

FIG. 3 is a view of a smart training shoe in accordance with one embodiment of the present disclosure;

FIG. 4 is a view of an electronic control system of a wearable device in accordance with one embodiment of the present disclosure;

FIGS. 5(a) and 5(b) illustrating types of pedals provided in a vehicle;

FIGS. 6(a) and 6(b) are views illustrating an aspect of operating a clutch pedal of a vehicle with a manual transmission;

FIGS. 7(a) to 7(c) are views illustrating aspects of operating an accelerator pedal and a brake pedal in either a vehicle with a manual transmission or a vehicle with an automatic transmission;

FIG. 8 is a flowchart illustrating a method of measuring movement information of the wearable device while excluding physical activities for driving a vehicle in accordance with one embodiment of the present disclosure;

FIGS. 9(a) to 9(c) are views illustrating examples of components of a device for performing a method of measuring movement information of the wearable device in accordance with another embodiment of the present disclosure; and

FIG. 10 is a flowchart illustrating a method of measuring movement information of the wearable device excluding those for driving a vehicle in accordance with another embodiment of the present disclosure.

### DETAILED DESCRIPTION

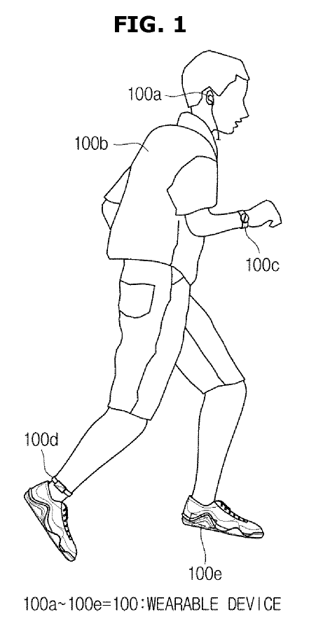

FIG. 1 is a view illustrating various types of wearable devices in accordance with one embodiment of the present disclosure.

Smart earphones (headset) 100a put on ears may allow a user to hear music, may inform the user of the receipt of a phone call, or may measure and record movement information while the user exercises including running, walking, etc. While the user exercises, smart earphones 100a not only play a sound source but also measure and record biosignals of the user using a biosensor mounted in the smart earphones 100a. For example, a cardiac impulse measurement sensor mounted in the smart earphones 100a may measure the number of cardiac impulses. The number of cardiac impulses measured as described may be transmitted to a terminal including a smart phone, etc. in real time and may be used as information for managing the health of the user.

A smart watch or a smart wrist band 100c put on a wrist occupies a large part of the market of wearable devices. The smart watch may not only function as a watch but also perform considerable part of functions implementable by a smart phone which interconnects with the smart watch. For example, phone calls, emails, messengers, and various applications may be autonomously serviced by the smart watch. As another wearable device put on a wrist is the smart wrist band. Due to being put on a wrist, the smart wrist band has an external shape reasonably similar to that of the smart watch but has a slight difference in function. The smart wrist band also provides a health management function such as measuring biometric information, for example, the amount of movement, and the amount of sleep and informing, etc. However, unlike the smart watch, the smart wrist band generally excludes additional communication functions including receiving a phone call, checking an email, etc.

Wearable devices are utilized not only in the form of the smart earphones 100a or the smart watch or smart wrist 100c but also in the form of smart clothing 100b that is a wearable device literally. The smart clothing 100b is formed by imbedding a micro sensor in fabric to measure and record a temperature, cardiac impulses, a movement speed, etc. of a human body.

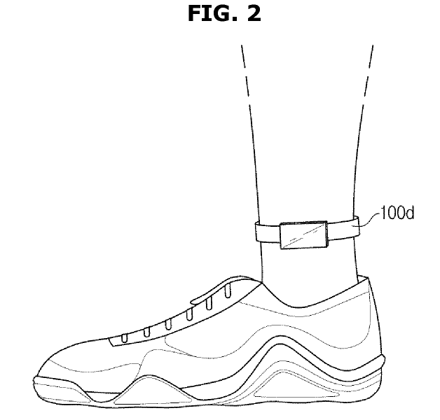

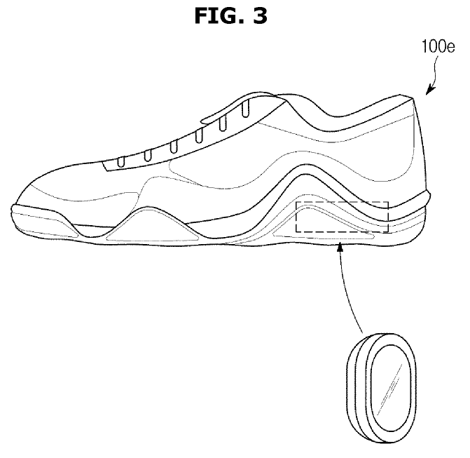

In addition to the smart wrist band or smart watch 100c put on a wrist, commercialization of smart training shoes 100e wearable on feet and a smart ankle band 100d wearable on an ankle is occurring. The smart training shoes 100e and the smart ankle band 100d will be described in detail with reference to FIGS. 2 and 3.

FIG. 2 is a view of a smart ankle band in accordance with one embodiment of the present disclosure. As shown in FIG. 2, the smart ankle band 100d includes a sensor capable of measuring biometric information and a display panel mounted thereon to check how much a user walks, runs, and goes upstairs and downstairs in a day and of even measuring and informing sleeping habits of the user. Since the smart ankle band 100d still functions under water, information on the amount of feet movement during swimming may also be provided. Although having no great difference in an external shape from the smart wrist band 100c, since the smart ankle band 100d has generally been developed with a focus to measuring a movement of a foot or a movement of an ankle joint, it is useful for physical activities mainly using feet such as running, walking, and cycling.

FIG. 3 is a view of the smart training shoe 100e in accordance with one embodiment of the present disclosure. In addition to the smart ankle band 100d, since the smart training shoes 100e which are wearable devices with chips embedded in training shoes have been developed with a focus to measuring movements of feet similar to the smart ankle band 100d, it is useful for measuring physical activities mainly using feet such as running, walking, and cycling.

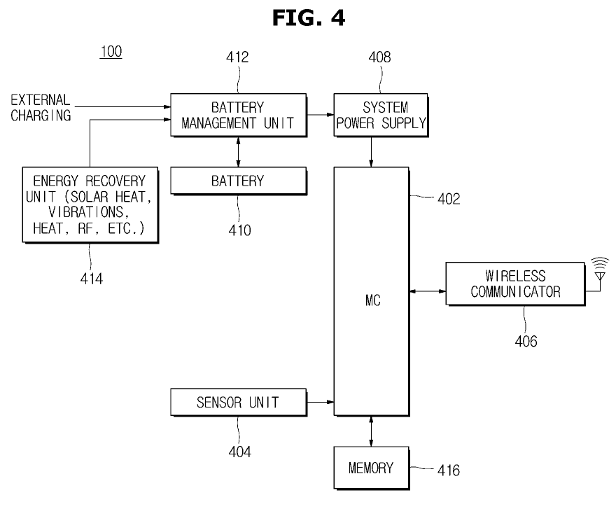

FIG. 4 is a view of an electronic control system of a wearable device in accordance with one embodiment of the present disclosure.

As shown in FIG. 4, a sensor unit 404 of a wearable device 100 is connected capable of communication to an input of a microcomputer (MC) (402). The sensor unit 404 may include various types of sensors as necessary. For example, sensors for detecting a temperature, cardiac impulses, physical activity amounts including an amount of movement of a hand or a foot, etc. may be provided in the sensor unit 404.

A wireless communicator 406 is connected capable of communication to an output of the MC 402. The wireless communicator 406 may employ at least one of radio frequency (RF) communication, Bluetooth communication, near field communication (NFC), and Zigbee communication. Also, other local area communication methods may be used in addition thereto. The MC 402 transmits information measured by the wearable device 100 to a smart phone, a server, etc. through the wireless communicator 406.

Power is supplied to the MC 402 and the wireless communicator 406 from a power supply system 408. The power supply system 408 receives power from a battery 410. The battery 410 is managed by a battery management unit 412. The battery 410 is charged by an energy recovery unit 414 or externally charged by an external charger.

The energy recovery unit 414 may charge the battery 410 by producing electric energy from solar heat, vibration, heat, RF, etc. Depending on a type of the wearable device 100, the energy recovery unit 414 may not be provided.

A memory 416 may store firmware, etc. necessary for controlling the sensor unit 404 and the wireless communicator 406 of the wearable device 100. Also, various data generated while a user uses the wearable device 100 may be stored. The data stored in the memory 416 are transmitted to the smart phone or server, etc. through the MC 402 and the wireless communicator 406.

A considerable number of such wearable devices are used to obtain information by measuring physical activities of users. Particularly, smart ankle bands or smart training shoes are provided to measure physical activities generated by feet. As the physical activities measured by the smart ankle band or smart training shoes, longitudinal movements and lateral movements of the entire foot or rotational movements of a foot around an ankle joint, a force applied to a sole of a foot, etc. may be included.

When the user gets in a vehicle and drives while wearing such smart ankle band or smart training shoes, additional physical activities generated while driving the vehicle may be measured as if pure physical activities in addition to the pure physical activities to be measured using a wearable device. Here, the pure physical activities to be measured using the wearable device means physical activities which themselves are a target of exercise such as walking, running, swimming, and cycling. The additional physical activities generated by a driver while driving the vehicle are only for driving the vehicle, not the target of exercise, and thus are necessary to be distinguished from the pure physical activities.

The wearable device in accordance with the embodiment of the present disclosure includes an operation mode for precisely measuring physical activities only in the case when the physical activities themselves are the target of exercise by excluding additional physical activities generated by driving a vehicle from the target of exercise to be measured when a user drives the vehicle while wearing the wearable device and the physical activities are measured. In this operation mode, the wearable device excludes unique physical activities generated while driving the vehicle from the target of exercise to be measured and measures as meaningful physical activities only physical activities where the pure physical activities themselves are the target of exercise.

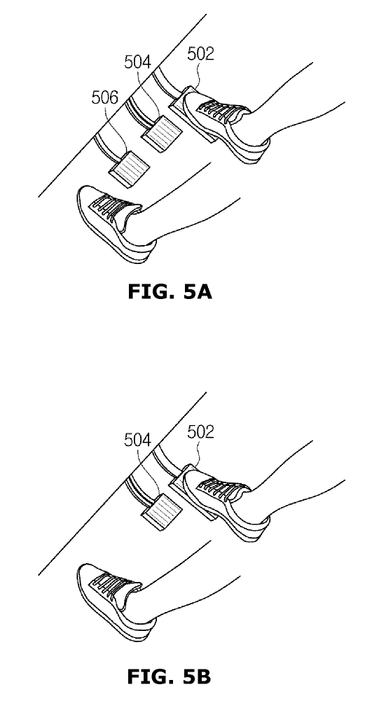

FIGS. 5(a) to 7(c) are views illustrating unique physical activities generated while driving a vehicle.

First, FIGS. 5(a) and 5(b) are views illustrating types of pedals provided in a vehicle.

FIG. 5(a) shows an accelerator pedal 502, a brake pedal 504, and a clutch pedal 506 provided in a vehicle with a manual transmission.

The accelerator pedal 502 is provided to increase revolutions per minute of an engine by controlling a throttle opening of the engine through an operation of a driver to increase a speed of the vehicle. Strictly, when an accelerator pedal 502 is pressed, engine power increases, thereby increasing a speed of a vehicle. However, when a pedal effort applied to the accelerator pedal 502 is removed, that is, the pedal is not pressed, the vehicle does not accelerate any more, is converted into a coasting mode, and then naturally decelerates.

An artificial deceleration of the vehicle is performed by operating the brake pedal 504. When the driver would like to more quickly and strongly brake the vehicle beyond naturally decelerating, the brake pedal 504 is pressed to operate a brake system on wheels, thereby generating a quick and strong braking force.

In the case of the vehicle with the manual transmission, changing speed of the transmission is manually operated by the driver. When the clutch pedal 506 is fully pressed to disconnect a gearshift from a drive system, a gear lever is operated to change speed, and when the changing of speed is completed, the pressed clutch pedal 506 is returned to a former condition thereof to connect the gearshift with the drive system.

FIG. 5(b) shows the accelerator pedal 502 and the brake pedal 504 provided in a vehicle with an automatic transmission. In the case of the vehicle with the automatic transmission, unlike the vehicle with the manual transmission, changing of speed is automatically performed by an electronic control unit (ECU) of the vehicle. Accordingly, a clutch pedal is unnecessary in the vehicle with the automatic transmission. The accelerator pedal 502 and the brake pedal 504 are identical to those of the vehicle with the manual transmission described with reference to FIG. 5(a).

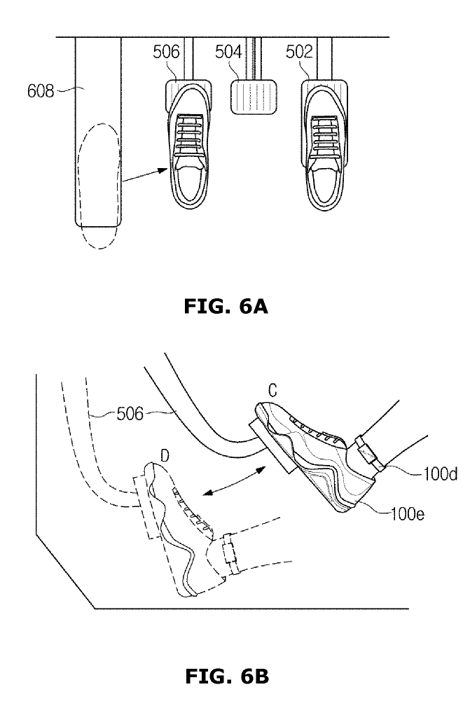

FIGS. 6(a) and 6(b) are views illustrating an aspect of operating a clutch pedal of a vehicle with a manual transmission.

While a driver operates the clutch pedal 506 of the vehicle with the manual transmission, a left foot of the driver moves as shown in FIG. 6(b). When the driver wears a smart ankle band 100d on a left ankle or a smart training shoe 100e on the left foot, it is determined from a movement of the left foot shown in FIG. 6(b) that the driver is driving, and movement information of the left foot of the driver measured through a wearable device is excluded from a measurement result of the wearable device. Thereby, the wearable device may measure pure movement information of the driver while excluding the movement information generated for driving the vehicle.

As shown in FIG. 6(a), the left foot of the driver who drives the vehicle with the manual transmission moves between the clutch pedal 506 and a footrest 608. Here, the footrest 608 is a place on which the left foot is put when the driver does not use the left foot and is provided on the left side of the clutch pedal 506. When the driver does not operate the clutch pedal 506, the left foot of the driver is located on the footrest 608. To operate the clutch pedal 506, the left foot of the driver is moved onto the clutch pedal 506. When an operation of the clutch pedal 506 for changing speed is completed, the left foot of the driver moves from the clutch pedal 506 to the footrest 608. Thereby, the left foot of the driver completes one cycle of movement between the footrest 608 and the clutch pedal 506. The movement of the left foot of the driver between the footrest 608 and the clutch pedal 506 may be repeatedly performed many times until driving is finished.

Also, to operate the clutch pedal 506, the left foot of the driver who drives the vehicle with the manual transmission performs reciprocating movement between an original position C of the clutch pedal 506 and a position D where a pedal effort is applied to the clutch pedal 506 as shown in FIG. 6(b). When the driver applies the pedal effort to the clutch pedal 506, the clutch pedal 506 moves from the original position C to the position where the pedal effort is applied, thereby disconnecting a gearshift from a drive system, and the driver operates a gear lever to perform changing of speed during that time. When the operating of the gear lever is completed, the driver removes the pedal effort from the clutch pedal 506, thereby allowing the clutch pedal 506 to return to the original position C. During the process of operating the clutch pedal 506 as described above, the left foot of the driver reciprocates between the position C and the position D. The reciprocation of the left foot of the driver between the position C and the position D may be repeatedly performed many times until driving is finished.

The wearable device may detect a bidirectional reciprocation between the positions C and D through an acceleration sensor (or a gyro sensor) mounted in the wearable device due to the reciprocation generated when the clutch pedal 506 is operated while the wearable device is worn on the left foot of the driver as described. When a series of operations of the clutch pedal 506 as described above are detected, the wearable device may determine that a user of the wearable device is currently driving.

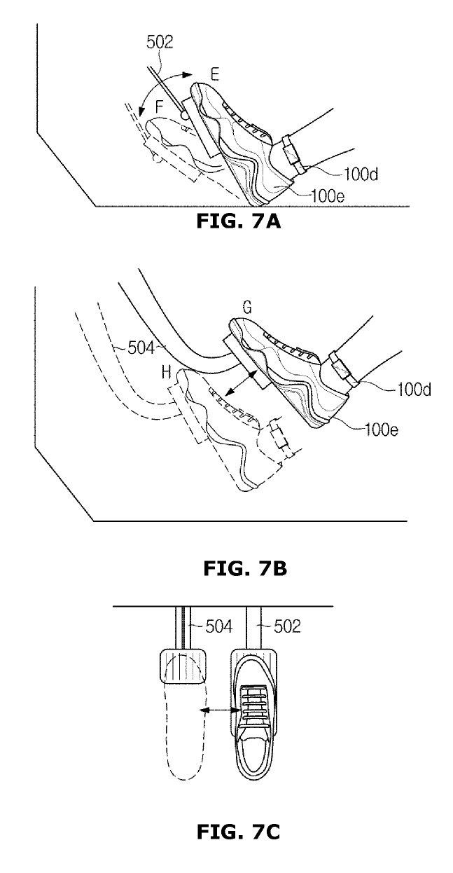

FIGS. 7(a) to 7(c) are views illustrating aspects of operating an accelerator pedal and a brake pedal in either a vehicle with a manual transmission or a vehicle with automatic transmission. FIG. 7(a) illustrates an aspect of operating the accelerator pedal 502, FIG. 7(b) illustrates an aspect of operating the brake pedal 504, and FIG. 7(c) illustrates an aspect of movement of a right foot between the accelerator pedal 502 and the brake pedal 504.

In the aspect of the operating the accelerator pedal 502 shown in FIG. 7(a), the driver put the right foot on the floor and moves an ankle joint to apply a pedal effort to the accelerator pedal 502 using a front of the right foot or remove the pedal effort to allow the accelerator pedal 502 to return to an original position. That is, while driving, the right foot of the driver is pivoted and reciprocated between a position E and a position F within a range of a maximum angle θ around the ankle joint to operate the accelerator pedal 502. The maximum angle θ is a range between an angle of the right foot when the accelerator pedal 502 is in an original position, that is, the position E and an angle of the right foot when the accelerator pedal 502 is fully pressed (full acceleration). The right foot of the driver repeatedly reciprocates within the range of the maximum angle θ while driving.

To operate the brake pedal 504, the right foot of the driver performs a reciprocation between an original position G of the brake pedal 504 and a position H where a pedal effort is applied to the brake pedal 504 as shown in FIG. 7(b). When the driver applies the pedal effort to the brake pedal 504, the brake pedal 504 moves from the original position G to the position H where the pedal effort is applied, thereby increasing friction between a brake disc of a wheel and a brake caliper to perform deceleration and braking of the vehicle. When a braking at a targeted level is performed, the driver removes the pedal effort from the brake pedal 504, thereby allowing the brake pedal 504 to return to the original position G. During the process of operating the brake pedal 504 as described above, the right foot of the driver reciprocates between the position G and the position H. The reciprocation of the right foot of the driver between the position G and the position H may be repeatedly performed many times until driving is finished.

As shown in FIG. 7(c), the right foot of the driver moves between the accelerator pedal 502 and the brake pedal 504 while driving. The right foot of the driver is put on the accelerator pedal 502 when the driver operates the accelerator pedal 502 and moves from the accelerator pedal 502 to the brake pedal 504 when the driver operates the brake pedal 504. After a deceleration at a targeted level is performed by operating the brake pedal 504, when an acceleration is necessary, the right foot of the driver moves from the brake pedal 504 to the accelerator pedal 502. Thereby, the right foot of the driver completes one cycle of movement between the accelerator pedal 502 and the brake pedal 504. The movement of the right foot of the driver between the accelerator pedal 502 and the brake pedal 504 may be repeatedly performed many times until driving is finished.

Accordingly, when a right foot of a user who wears a wearable device is pivoted and vertically reciprocate within the range of the maximum angle θ as shown in FIG. 7A, reciprocates with a certain depth as shown in FIG. 7B, laterally moves a certain distance as shown in FIG. 7C, or two or more combinations of the three movement aspects are performed, the wearable device may determine that the user who wear the wearable device is currently driving.

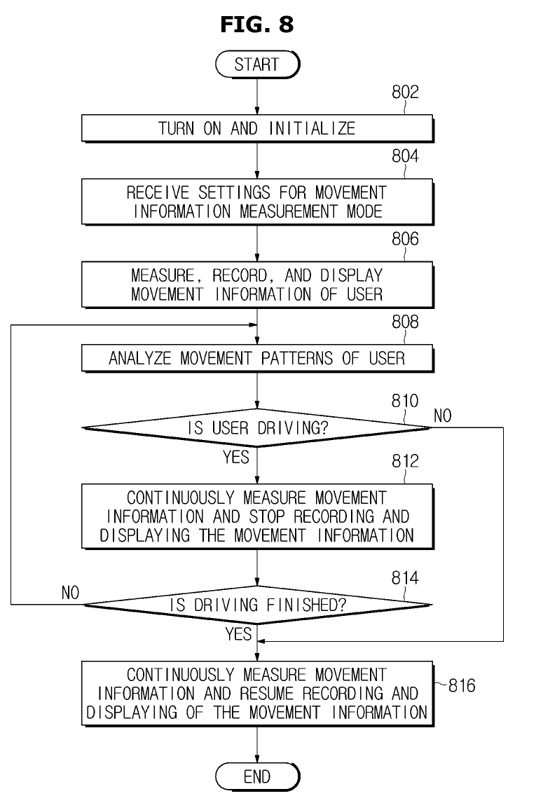

FIG. 8 is a flowchart illustrating a method of measuring movement information of the wearable device while excluding physical activities for driving a vehicle in accordance with one embodiment of the present disclosure. In the method of measuring the movement information of a wearable device 100 in accordance with the embodiment of the present disclosure shown in FIG. 8, unique physical activities generated while driving the vehicle are excluded from a target of exercise to be measured, and only pure physical activities where the physical activities of themselves are the target are measured as meaningful physical activities.

When a user turn on the wearable device 100 while wearing or mounting the wearable device 100 on ankles or in training shoes, the MC 402 (refer to FIG. 4) of the wearable device 100 initializes and converts the wearable device 100 into an operable state (802).

Afterwards, when the user sets the wearable device 100 in a movement information measurement mode, the MC 402 receives the user settings and converts the wearable device 100 into the movement information measurement mode (804).

In the movement information measurement mode, the wearable device 100 measures movement information of the user to record and display (806). The record of the movement information may be stored in the memory 416 (refer to FIG. 4) or may be transmitted to an external device through the wireless communicator 406. The movement information may be displayed by a display of the wearable device 100.

While measuring the movement information of the user, the wearable device 100 analyzes movement patterns of the user (808). The analyzing of the movement patterns of the user performed by the wearable device 100 in accordance with the embodiment of the present disclosure is to determine whether the movement information of the user currently measured is on pure physical activities of the user or additional physical activities generated by driving of the vehicle. Here, the pure physical activities to be measured using the wearable device 100 means physical activities which themselves are a target of exercise such as walking, running, swimming, and cycling. The additional physical activities generated by the driver while driving the vehicle are only for driving the vehicle, not the target of exercise, and thus necessary to be distinguished from the pure physical activities. The analyzing of the movement patterns of the user may include analyzing whether unique operations generated by driving as described with reference to FIGS. 6(a) to 7(c) are performed. When the unique operations generated by driving as shown in FIG. 5(a) to FIG. 7(c) are included in the movement information measured through the wearable device 100, since it becomes the adequate basis for determining that the user is currently driving, physical activities of the user in this case may be determined to be the additional physical activities generated by driving.

When it is determined that the user is currently driving according to the criteria and basis described above (YES in S810), the currently measured movement information is determined to be movement information measured while driving and excluded from recording and displaying (812). That is, the additional physical activities generated during the process of driving the vehicle are excluded from the recording and displaying, thereby recording and displaying only the pure physical activities.

When it is determined that the user finishes driving (YES in S814), the wearable device 100 continues to measure the movement information of the user and resumes the recording and displaying of the movement information (816). While the wearable device 100 operates in the movement information measurement mode, even though the driver performs driving, the movement information measurement of the driver is continuously performed. Since the movement information measured at this time is not meaningful, only the official recording and displaying thereof are limited. Accordingly, when the user finishes driving, the movement information measurement performed up to this point is continued and the discontinued recording and displaying are resumed, thereby allowing pure movement information of the user after the driving is finished to be recorded and displayed.

When the user continues driving (NO in 814), the measuring of the movement information of the user and analyzing of the movement patterns are repeatedly performed. Also, since the user is currently driving, a process of excluding the movement information measured while driving from the recording and displaying is continuously performed until the driving is finished.

When it is determined that the user is not driving (No in 810), the wearable device 100 continues to measure the movement information of the user and continues recording and displaying the movement information (816).

As shown in FIG. 8, it is determined by analyzing the movement patterns of the user whether the user is driving or not, and the movement information measured while driving is excluded from the recording and displaying, thereby excluding the additional physical activities involved in activities including driving, etc. and recording and displaying only the pure physical activities. Particularly, since it is processed by software to check whether the user is driving by analyzing the movement patterns of the user, the wearable device 100 may measure the movement information with a consideration given to driving in accordance with the embodiment of the present disclosure merely through updating firmware without replacing existing hardware of the wearable device 100.

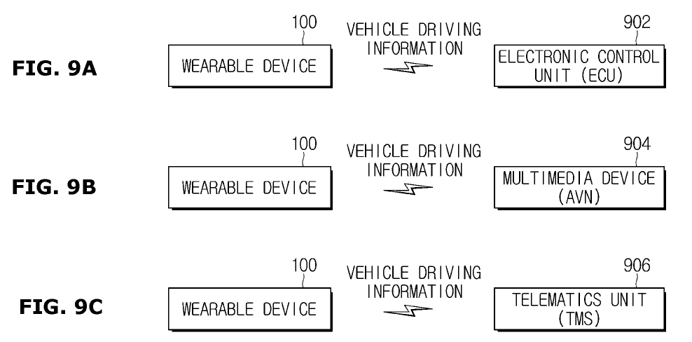

FIGS. 9(a) to 9(c) are views illustrating examples of components of a device for performing a method of measuring exercise information of the wearable device in accordance with another embodiment of the present disclosure.

The examples of components of the device shown in FIGS. 9(a) to 9(c) allow the wearable device 100 to receive vehicle driving information from a vehicle to check whether the vehicle is driven and to check therefrom that the user of the wearable device 100 is currently driving the corresponding vehicle. The wearable device 100 and the vehicle may recognize each other through a process of registering/pairing, etc. in advance.

As shown in FIG. 9(a), the wearable device 100 may receive vehicle driving information from an ECU 902 of the vehicle and may determine that the user is currently driving through the vehicle driving information. The vehicle driving information transmitted from the ECU 902 to the wearable device 100 may include at least one of engine-starting information, speed-changing information, and speed information. The wearable device 100 may determine that the user is currently driving through at least one of the engine-starting information, the speed-changing information, and the speed information received from the vehicle. As necessary, even though driving may be checked merely through the engine-starting information, to more precisely check the driving, the speed-changing information or the speed information may preferably be considered in addition to the engine-starting information to check the driving.

As shown in FIG. 9(b), the wearable device 100 may receive vehicle driving information from a multimedia device 904 such as an audio video navigation system (AVN) of the vehicle and may determine that the user is currently driving through the vehicle driving information. The wearable device and the multimedia device 904 may be paired to perform Bluetooth communication. Additionally, communication methods including wireless fidelity (Wi-Fi), Zigbee, near field communication (NFC), etc. may be used. The vehicle driving information transmitted from the multimedia device 904 to the wearable device 100 may include at least one of engine-starting information, speed-changing information, and speed information. The wearable device 100 may determine that the user is currently driving through at least one of the engine-starting information, the speed-changing information, and the speed information received from the vehicle. As necessary, even though driving may be checked merely through the engine-starting information, to more precisely check the driving, the speed-changing information or the speed information may preferably be considered in addition to the engine-starting information to check the driving.

As shown in FIG. 9(c), the wearable device 100 may receive vehicle driving information from a telematics device 906 of the vehicle and may determine that the user is currently driving through the vehicle driving information. The wearable device 100 and the telematics device 906 may communicate with each other through a wireless communication network of 3G, long term evolution (LTE), etc. formed by the telematics device 906. Additionally, communication methods including Wi-Fi, Zigbee, NFC, etc. may be used. The vehicle driving information transmitted from the telematics device 906 to the wearable device 100 may include at least one of engine-starting information, speed-changing information, and speed information. The wearable device 100 may determine that the user is currently driving through at least one of the engine-starting information, the speed-changing information, and the speed information received from the vehicle. As necessary, even though driving may be checked merely through the engine-starting information, to more precisely check the driving, the speed-changing information or the speed information may preferably be considered in addition to the engine-starting information to check the driving.

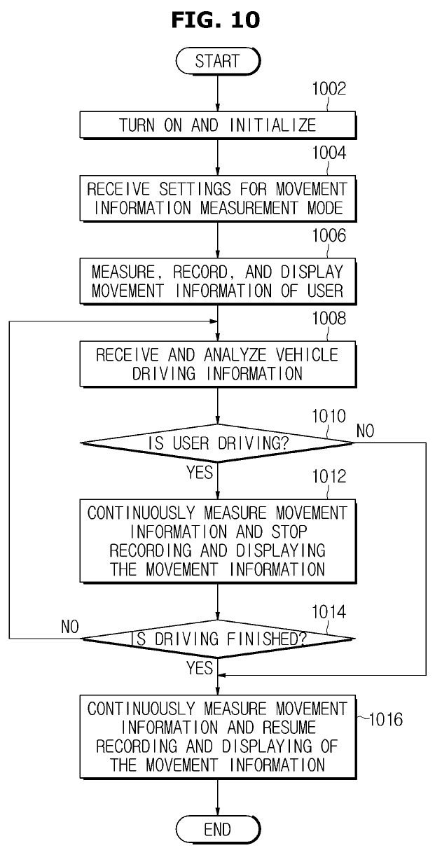

FIG. 10 illustrates a method of measuring movement information of the wearable device excluding physical activities for driving a vehicle in accordance with another embodiment of the present disclosure. In the method of measuring the movement information of the wearable device 100 in accordance with the embodiment of the present disclosure shown in FIG. 10, unique physical activities generated while driving the vehicle are excluded from a target to be measured and only pure physical activities where physical activities of themselves become the target are measured as meaningful physical activities.

When a user turn on the wearable device 100 while wearing the wearable device 100 on ankles or mounting in training shoes, the MC 402 (refer to FIG. 4) of the wearable device 100 initializes and converts the wearable device 100 into an operable state (1002).

Afterwards, when the user sets the wearable device 100 in a movement information measurement mode, the MC 402 receives the user settings and converts the wearable device 100 into the movement information measurement mode (1004).

In the movement information measurement mode, the wearable device 100 measures movement information of the user to record and display (1006). The record of the movement information may be stored in the memory 416 (refer to FIG. 4) or may be transmitted to an external device through the wireless communicator 406. The movement information may be displayed by a display of the wearable device 100.

While measuring the movement information of the user, the wearable device 100 receives and analyzes vehicle driving information from the vehicle (1008). The receiving and analyzing of the vehicle driving information performed by the wearable device 100 in accordance with the embodiment of the present disclosure is to determine whether the movement information of the user currently measured is on pure physical activities of the user or additional physical activities generated by driving the vehicle. Here, the pure physical activities to be measured using the wearable device 100 means physical activities which themselves are a target of exercise such as walking, running, swimming, and cycling. The additional physical activities generated by the driver while driving the vehicle are only for driving the vehicle, not the target of exercise, and thus are necessary to be distinguished from the pure physical activities. The receiving and analyzing of the vehicle driving information may include checking whether the vehicle is being driven by considering at least one of the engine-starting information, the speed-changing information, and the speed information from the vehicle driving information received from one of the ECU 902, the multimedia device 904, and the telematics device 906 as described with reference to FIGS. 9(a) to 9(c).

When it is determined that the user is currently driving according to the analyzing of the vehicle driving information described above (YES in 1010), the currently measured movement information is determined to be movement information measured while driving and excluded from recording and displaying (1012). That is, the additional physical activities generated during the process of driving the vehicle are excluded from the recording and displaying, thereby recording and displaying only the pure physical activities.

When it is determined that the user is finished with driving (YES in 1014), the wearable device 100 continues to measure the movement information of the user and resumes the recording and displaying of the movement information (1016). While the wearable device 100 operates in the movement information measurement mode, even though the driver performs driving, the movement information measurement of the driver is continuously performed. Since the movement information measured during this time is not meaningful, only the official recording and displaying thereof are limited. Accordingly, when the user finishes driving, the movement information measurement performed up to this point is continued and the recording and displaying which are discontinued are resumed, thereby allowing pure movement information of the user after the driving is finished to be recorded and displayed.

When the user continues driving (NO in 1014), the receiving and analyzing of the vehicle driving information are repeatedly performed. Also, since the user is currently driving, a process of excluding the movement information measured while driving from recording and displaying is continuously performed until the driving is finished.

When it is checked that the user is not driving in the aforementioned 1010 step (No in 1010), the wearable device 100 continues to measure the movement information of the user and continues recording and displaying the movement information (1016).

As shown in FIG. 10, it is checked by directly receiving and analyzing the vehicle driving information whether the user is driving or not, and the movement information measured while the user is driving is excluded from the recording and displaying, thereby excluding the additional physical activities involved in activities including driving, etc. and recording as well as displaying only the pure physical activities. Particularly, whether or not driving is checked against the vehicle driving information of the vehicle, thereby advantageously providing a possibility to precisely measure the movement information in accordance with the embodiment of the present disclosure with considerations given to driving.

As is apparent from the above description, it is possible to precisely measure physical activities only where the physical activities themselves are a target of exercise by excluding additional physical activities generated by driving a vehicle from the target of exercise to be measured when a user drives the vehicle while wearing a wearable device and the physical activities are measured.

Although a few embodiments of the present disclosure have been shown and described, it would be appreciated by those skilled in the art that changes may be made in these embodiments without departing from the principles and spirit of the disclosure, the scope of which is defined in the claims and their equivalents.

What is claimed is:

1. A method of controlling a wearable device, comprising:
obtaining movement information of a user;
determining, based on the obtained movement information of the user, whether the user is driving a vehicle;
upon determination that the user is driving the vehicle, excluding the movement information of the user obtained while the user is driving the vehicle from recording or displaying the movement information of the user; and
upon determination that the user finishes driving the vehicle, continuing to measure the movement information of the user and resuming the recording or displaying of the movement information of the user.

2. The method of claim 1, wherein the movement information of the user comprises movement information of a body part on which the wearable device is located.

3. The method of claim 2, wherein the wearable device is located on an ankle of the user.

4. The method of claim 2, wherein the wearable device is located on a shoe on a foot of the user.

5. The method of claim 1, wherein the movement information is movement information generated while a left foot of the user operates a clutch pedal of the vehicle.

6. The method of claim 1, wherein the movement information is movement information generated while a right foot of the user operates at least one of an accelerator pedal and a brake pedal of the vehicle.

7. A method of controlling a wearable device, comprising:
obtaining movement information of a user;
performing communication with a vehicle;
determining, through the communication with the vehicle, whether the user is driving the vehicle;
upon determination that the user is driving the vehicle, excluding the movement information of the user obtained while the user is driving the vehicle from recording or displaying the movement information of the user; and
upon determination that the user finishes driving the vehicle, continuing to measure the movement information of the user and resuming the recording or displaying of the movement information of the user.

8. The method of claim 7, wherein the wearable device obtains driving information of the vehicle through the communication with the vehicle.

9. The method of claim 8, wherein the driving information of the vehicle is obtained from an electronic control unit (ECU) of the vehicle through communication between the ECU and the wearable device.

10. The method of claim 8, wherein the driving information of the vehicle is obtained from a multimedia device of the vehicle through communication between the multimedia device and the wearable device.

11. The method of claim 8, wherein the driving information of the vehicle is obtained from a telematics device of the vehicle through communication between the telematics device and the wearable device.

12. The method of claim 8, wherein the driving information of the vehicle comprises at least one of engine-starting information, speed-changing information, and speed information.

13. A wearable device comprising:
a detector for obtaining movement information of a user; and
a controller which excludes the movement information of the user obtained while the user is driving a vehicle from recording or displaying the movement information of the user upon determination based on the obtained movement information of the user that the user is driving and continues to measure the movement information of the user and resumes the recording or displaying of the movement information of the user upon determination that the user finishes driving the vehicle.

14. The wearable device of claim 13, wherein the detector comprises an acceleration sensor for detecting physical activities of the user.

15. The wearable device of claim 13, wherein the movement information of the user comprises movement information of a body part on which the wearable device is located.

16. The wearable device of claim 15, wherein the wearable device is located on an ankle of the user.

17. The wearable device of claim 15, wherein the wearable device is located on a shoe on a foot of the user.

18. The wearable device of claim 13, wherein the movement information is movement information generated while a left foot of the user operates a clutch pedal of the vehicle.

19. The wearable device of claim 13, wherein the movement information is movement information generated while a right foot of the user operates at least one of an accelerator pedal and a brake pedal of the vehicle.
